(19) United States
(12) Patent Application Publication
(10) Pub. No.: US 2005/0215244 A1
(43) Pub. Date: Sep. 29, 2005

(54) Device, and associated method, for monitoring a meter

(75) Inventor: Oyle Verdell Whitson, Corinth, TX (US)

Correspondence Address: Jack D. Stone, Jr.;Scheef & Stone, L.L.P., Suite 1400, 5956 Sherry Lane, Dallas, TX, 75225, US

(73) Assignee: Metrum Technologies, LLC, Waco, TX (US)

(21) Appl. No.: 11/092,287

(22) Filed: Mar. 28, 2005

Related U.S. Application Data
(60) Provisional application No. 60/556,619, filed on Mar. 26, 2004.

(51) Int. Cl. H04M 3/00

(52) U.S. Cl. 455/420

(57) ABSTRACT

An antenna is adapted for receiving via a CDMA/1xRTT digital wireless cellular radio communications network incoming data from a remote control station, and for transmitting via a wireless cellular communications network outgoing data to the remote control station. A cellular modem is connected to the antenna for establishing a wireless telephony data connection, and a processor is connected to the modem for receiving and processing incoming data, and for processing and communicating outgoing data to the modem for transmission via the antenna and the wireless cellular communications network to the remote control station. A communication interface is connected to the processor and connectable to the meter for communicating incoming data from the processor to the meter, and for communicating the outgoing data from the meter to the processor. A power supply is connected for supplying power to the processor and the modem.

### CLAIM OF PRIORITY

This application claims priority from U.S. Provisional Patent Application No. 60/556,619 entitled “METHOD AND SYSTEM FOR FACILITATING RADIO DATA COMMUNICATION WITH AN ELECTRIC METER” filed on behalf of Ovie Whitson on Mar. 26, 2004, and incorporated by reference herein in its entirety.

### TECHNICAL FIELD

The invention relates generally to two way communications for monitoring and receiving data from a meter and, more particularly, to a device and method for facilitating wireless digital cellular remote data communications for monitoring utility meters, such as electric meters, gas meters, and water meters, as well as automatic teller machines (ATM's), remote terminal units (RTUs), end point devices, and the like.

### BACKGROUND

Utility meters are commonly used to measure a quantity of electricity, water, or gas utilized by consumers. These measured and calculated quantities generated by the meter are collected by a utility company and used for billing purposes, system analysis, troubleshooting and, in some cases, are provided to the customer for internal management and optimization of processes.

If the meters are located in hard-to-reach areas, restricted areas, or if the need for more frequent access to data exists, then it is preferable for the meters to be monitored remotely, and for data generated from a meter reading to be electronically acquired and transmitted to where it is needed. Such acquisition and transmissions may be effectuated via a wireline transmission, if a wireline is available, or may be set up for such transmission.

If a wireline transmission is not available or it is not feasible to set one up, then it is desirable to be able to transmit meter reading data via a wireless link. However, many conventional meters are not capable of wireless communication.

Therefore, what is needed is an apparatus and method for facilitating wireless communication and acquisition of meter reading data from conventional electric meters.

### SUMMARY

The present invention, accordingly, provides an apparatus for wirelessly monitoring a meter, wherein an antenna is adapted for receiving via a CDMA/1xRTT digital wireless cellular radio communications network incoming data from a remote control station, and for transmitting via a wireless cellular communications network outgoing data to the remote control station. A cellular modem is connected to the antenna for establishing a wireless telephony data connection, and a processor is connected to the modem for receiving and processing incoming data, and for processing and communicating outgoing data to the modem for transmission via the antenna and the wireless cellular communications network to the remote component. A communication interface is connected to the processor and connectable to the meter for communicating incoming data from the processor to the meter, and for communicating the outgoing data from the meter to the processor. A power supply is connected for supplying power to the processor and the modem.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram exemplifying one embodiment of a device embodying features of the present invention for use with CDMA/1xRTT digital cellular radio for a solid state electric meter;

FIG. 2 is a schematic diagram exemplifying one embodiment of a power supply for use with the device of FIG. 1;

FIG. 3 is a schematic diagram exemplifying one embodiment of a processor for use with the device of FIG. 1;

FIG. 4 is a schematic diagram exemplifying one embodiment of a modem for use with the device of FIG. 1;

FIG. 5 is a schematic diagram exemplifying one embodiment of optical isolators for use with the device of FIG. 1;

FIG. 6 is a schematic diagram exemplifying one embodiment of an RS-232 serial port for use with the device of FIG. 1; and

FIG. 7 depicts a flow chart exemplifying control logic for retrieving data from the meter through the device of FIG. 1.

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure in unnecessary detail the drawings of the present invention, or detail has been depicted in the drawings without corresponding detail in the text in order not to obscure in unnecessary detail the written description of the present invention. Additionally, for the most part, details concerning wireless communications and the like have been omitted inasmuch as such details are not considered necessary to obtain a complete understanding of the present invention, and are considered to be within the skills of persons of ordinary skill in the relevant art.

It is noted that, unless indicated otherwise, all functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

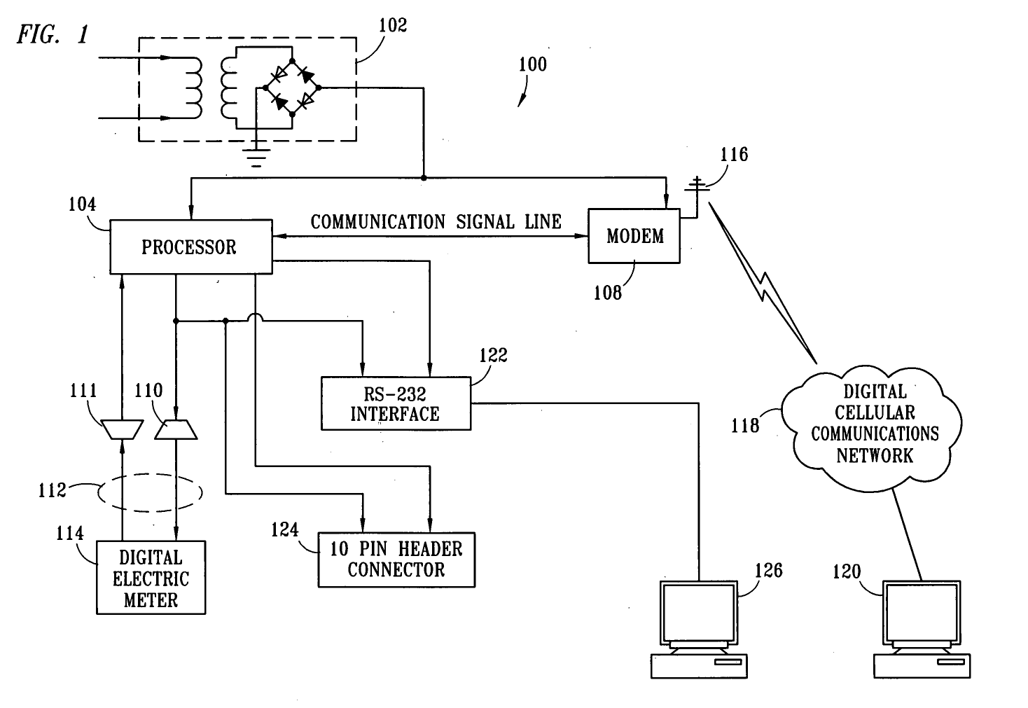

Referring to FIG. 1 of the drawings, the reference numeral 100 generally designates an apparatus embodying features of the present invention for facilitating two-way wireless remote communications for monitoring and receiving data from a meter. As discussed in further detail below, the apparatus 100 includes a power supply 102 connected for supplying direct current (DC) power to a processor 104 and a modem 108. The processor 104 is preferably connected via optical-isolators 110 and 111 and an interface 112 to a meter 114, such as a solid state electric meter. The processor 104 is also connected to a cellular modem 108 for communicating data between the processor and modem. The modem 108 is connected to an antenna 116 effective for transmitting and receiving radio signals across a CDMA/1xRTT digital wireless cellular radio communications network 118 to a remote control station 120. In a preferred embodiment, an RS-232 communication port 122 and a 10-pin header communication port 124 are also provided for additional functions, such as diagnostic testing and programming of the processor 104, the modem 108, and the meter 114, as discussed in further detail below.

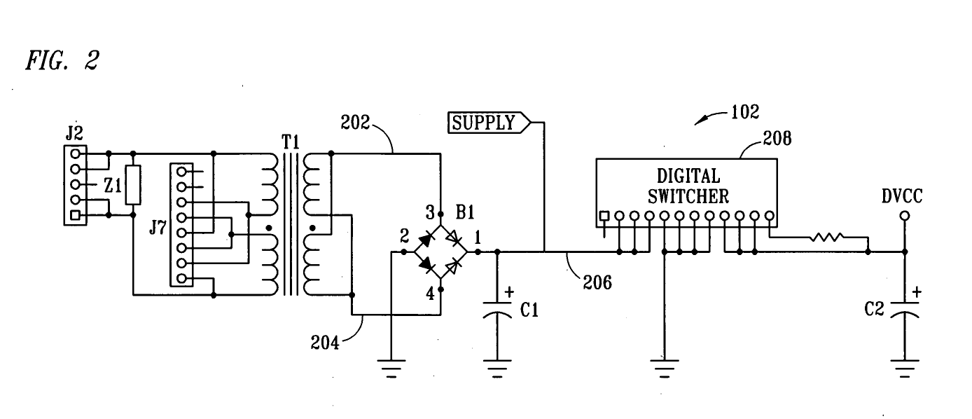

FIGS. 2-6 exemplify, without limitation, details of one preferred embodiment of the components presented above with respect to FIG. 1. It is noted that various connector labels are depicted in FIGS. 2-6 to designate in a conventional manner how various components of the device 100 are interconnected together.

Accordingly, FIG. 2 exemplifies a power supply 102, which is preferably an auto-ranging power supply, thereby being effective for receiving a range of primary line voltages, such as a range of about 80 volts of alternating current (VAC) to about 520 VAC, and transforming the line voltage to a direct current (DC), preferably having an output voltage in the range of about 4 to 6 VAC, and preferably about 5 volts DC (VDC) for use by the processor 104 and modem 108 and other components of the device 100.

More specifically, line power preferably having a current of about 2 to 3 amperes is preferably received, via a power connector J2, from an AC power source (not shown) preferably external of the meter 114, such as the power source supplying power to the meter. The power received via the power connector J2 is carried via two wires to a transformer T1. A metal oxide varistor (MOV) Z1, sized to short-circuit at approximately 1100 volts, is preferably connected in parallel on the high side of the transformer T1 for protecting the transformer T1 from power surges. The transformer T1 is preferably a conventional transformer adapted for converting the primary line voltage received from the connector J2 to an output voltage in the range of 4 to 6 VAC, and preferably about 5 VAC. A bridge rectifier B1 is connected to the output of the transformer T1 for converting the AC to DC in a conventional manner for use via a line 206 by the processor 104 and modem 108. Two capacitors C1 and C2, connected to grounds for the lines 204 and 206 respectively, and each rated at about 270 μF and 50 V, are provided to ground AC components of the current that may pass through the bridge rectifier B1. Power is regulated with a switcher 208 connected to the line 206 for conditioning and regulating the power to specific hardware requirements. In an alternative embodiment of the invention, the power supply 102 may comprise a conventional battery (not shown) of suitable capacity, or may be supplemented by a battery. Power supplies are generally considered to be well-known in the art, and therefore will not be described in further detail herein.

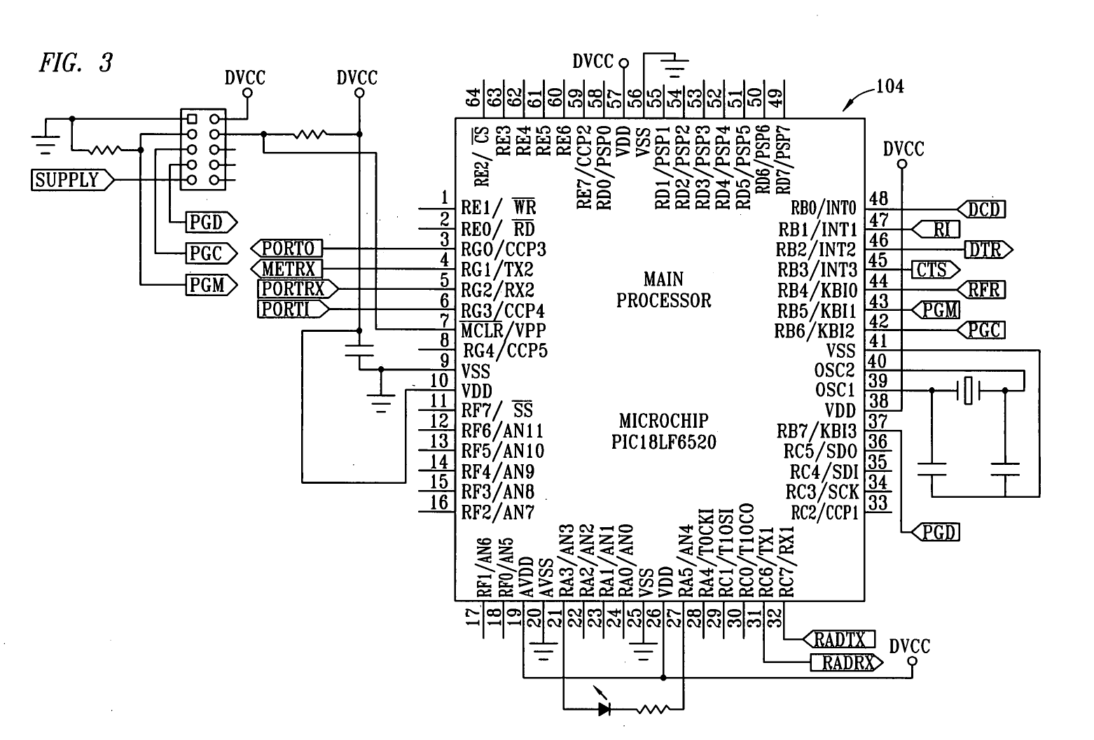

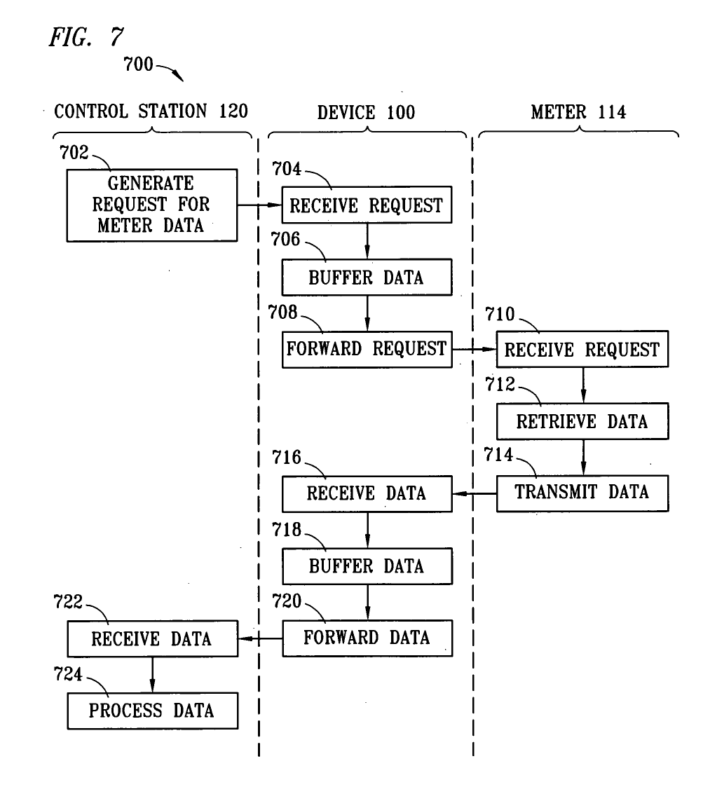

FIG. 3 exemplifies the processor 104 as a Microchip PIC18LF6520, though any of a number of conventional processor may be utilized, which is effective for buffering about 80 bytes to 256 bytes of data, includes multiple serial ports, such as defined by pins 3-6, 31-32, and 42-48, through which simultaneous communications via multiple Universal Synchronous/Asynchronous Receiver/Transmitters (USARTs) may be effectuated to interface with the modem 108, meter 114, and communication ports 122 and 124, and for executing code to effectuate the logic depicted by flow chart 700, described below with respect to FIG. 7. The processor 104 is preferably operable for executing code written in assembly language. Still further, the processor 104 is preferably configured for enabling the device 100 to redirect packet buffering and voltage levels (i.e., TTL) out to signal processes from the modem 108 and the meter 114 (e.g., buffering the packet from the meter 114 which exceeds the buffering capability of the modem 108). The multiple serial ports of the processor 104 enables the device 100 to perform the above buffering and control different signal processes from the modem 108 to the meter 114. This provides signal processes with flow control and data terminal functions, without causing modem buffers to overflow resulting in a timeout condition and termination of a communication session. Processors such as the processor 104 are considered to be well-documented in publicly available technical literature, and are otherwise considered to be well-known in the art and, therefore, will not be described in further detail herein, except as appropriate to describe the invention.

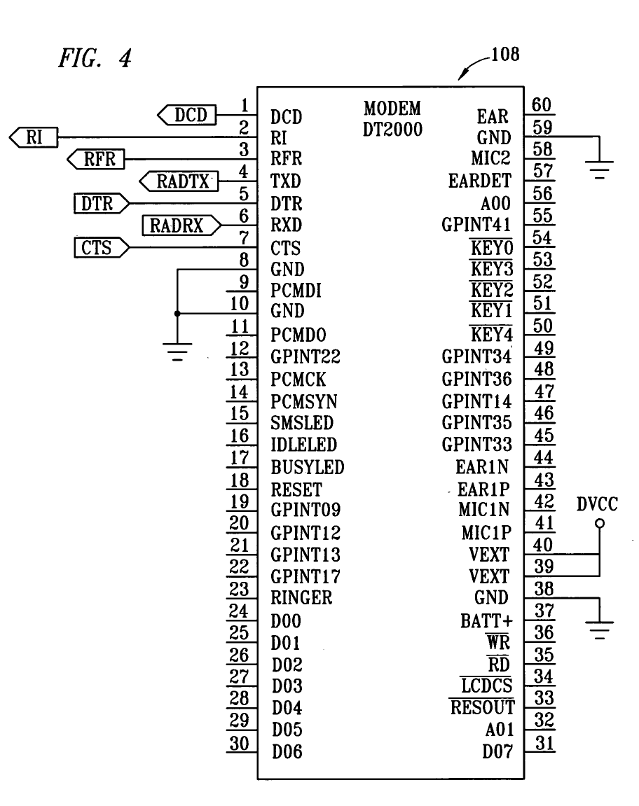

FIG. 4 exemplifies the cellular modem 108 as though any conventional circuit-switched cellular data modem may be utilized, which is operable in a packet data (i.e., TCP/IP) mode and a circuit switch mode, and which is effective for demodulating CDMA/1xRTT digital cellular communication signals received by the antenna 116 for processing by the processor 104, and for modulating signals received from the processor 104 for transmission as CDMA/1xRTT digital cellular communication signals from the antenna 116, to thereby establish a wireless telephony data connection via the CDMA/1xRTT digital cellular communication network 118 with the remote control station 120. The modem 108 is also preferably operable for receiving incoming data and transmitting outgoing data utilizing a protocol such as IS-95A/B, Dynamic Host Configurable Protocol (DHCP), a static Internet protocol (IP), and the like. Modems such as the modem 108 are considered to be well-documented in publicly available technical literature, and are otherwise considered to be well-known in the art and, therefore, will not be described in further detail herein.

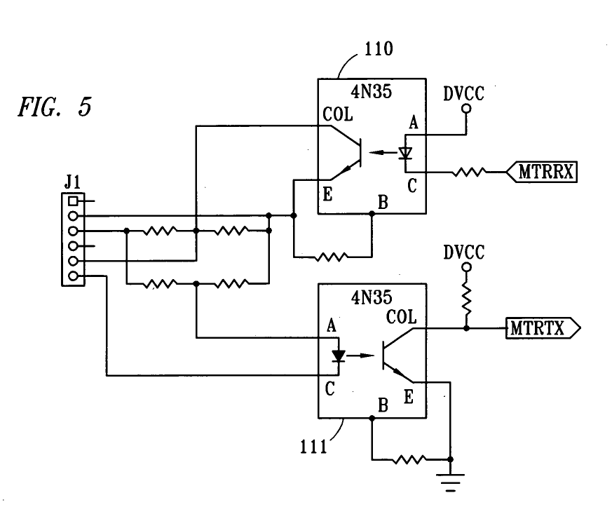

FIG. 5 illustrates the optical isolators 110 and 111, which are effective for electrically isolating the processor 104 from voltage ground planes of the interface 112, and for enabling the modem 108 and antenna 116 to connect to a negative ground. More specifically, the optical isolators 110 and 111 are operable for using a transistor-to-transistor logic (TTL) communication protocol between the processor 104 and the meter 114. It may be appreciated that, together with the interface 112, the optical isolators 110 and 111 facilitate using a TTL communication protocol between the processor 104 and the meter 114. While optical isolators 110 and 111 are depicted in FIG. 5 as being a conventional 4N35, any conventional 6-Pin DIP package phototransistor output optical isolator (also referred to as an optocoupler) may be utilized. Because optical isolators are generally considered to be well-known in the art, the optical isolators 110 and 111 will not be described in further detail herein.

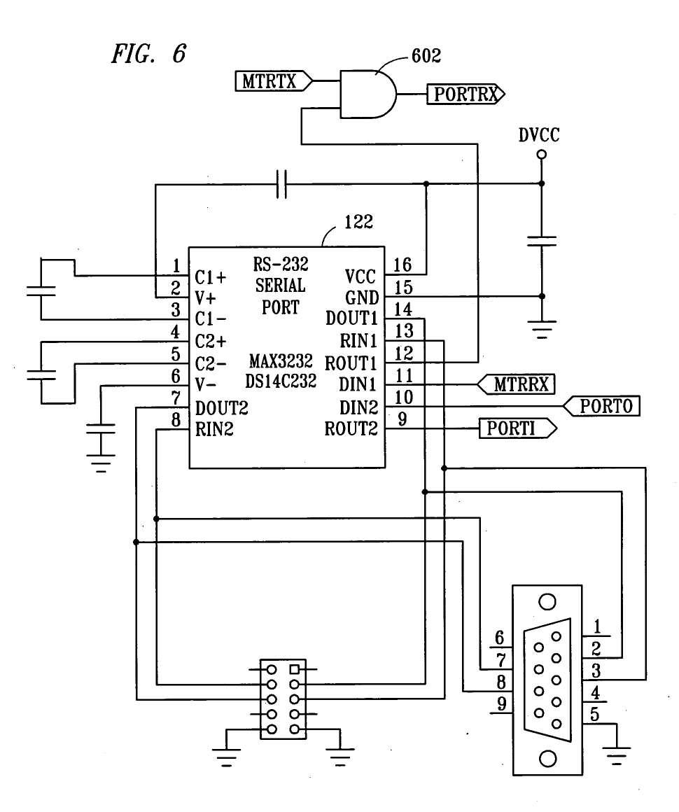

FIG. 6 illustrates the communications port 122, which is preferably configured as an RS-232 serial port using MAX3232 DS14C232 chip, although any suitable chip may be utilized. The reference numeral 602 designates a regulator utilized in connection with the port 122. Because RS-232 serial ports are generally considered to be well-known in the art, the port 122 will not be described in further detail herein.

It should be appreciated that components, such as the meter 114, or alternatively, with a gas meter, a water meter, an automated teller machine (ATM), a remote terminal unit (RTU) 126, and/or other end point devices, such as, but not limited to, a pump, an electric power regulator, capacitors, relays, operational control reclosure (OCR), and the like, may be connected to either the RS-232 serial port or the interface 112. Furthermore, either the RS-232 serial port or the interface 112 may be utilized to diagnose, program, or retrieve data from, any of the aforementioned components connected to the RS-232 serial port or the interface 112. By way of example, but not limitation, the RS-232 serial port or the interface 112 may be used to facilitate diagnosing the device 100, diagnosing, programming, communicating with, and retrieving data (e.g., billing data) from the meter 114 or other component connected to the RS-232 serial port or the interface 112, programming (e.g., entering a phone number) of the modem 108, determining signal strength and quality of wireless communications, programming of the processor 104, and the like.

Referring back to FIG. 1, the communication port 124 is preferably a 10-pin header connector, which is operable using a TTL communication protocol to facilitate diagnosing and programming the processor 104.

The antenna 116 is a conventional antenna, preferably adapted for communicating at two or more digital cellular communication frequencies, or bands. More specifically, the antenna 16 is preferably a tri-band antenna which may be mounted either internally or externally of the meter 114.

The remote control station 120 is an electronic data processor, such as a conventional computer, operable for establishing a telephony data connection via the communications network 118 with the device 100 and meter 114 to retrieve data from the meter, diagnose the meter, or program the meter, or any device connected to the RS-232 serial port 122.

In operation, the device 100 is operable in at least two different modes. In a first mode, the device 100 works in conjunction with conventional solid state electric meters. On the meter 114, the device 100 is preferably installed under the cover of the meter 114 and connects to the meter's communication interface provided on the meter. In a second mode, the device 100 works in conjunction with meters utilizing RS-232 ports, facilitated by the RS-232 port 122.

FIG. 7 is a flow chart of preferred control logic implemented by the processor 104 for retrieving meter data from the meter 114 or other component connected to the RS-232 serial port or the interface 112, in accordance with principles of the present invention. For the purpose of illustration, the flow chart 700 will be described representatively herein with respect to the meter 114 connected via the interface 112 to the processor 104. Accordingly, in step 702, the remote control station 120 generates a request message for meter data, and transmits the request message via the communications network 118 to the device 100. In step 704, the modem 108 of the device 100 receives the request message, also referred to herein as incoming data, via the antenna 116 and forwards the request message to the processor 104. In step 706, the processor 104 buffers the request message and, in step 708, adjusts the baud rate as necessary and forwards the request message, via the interface 112, to the meter 114, and enters into a wait state until receipt of data in step 716, described below. In step 710, the meter 114 receives the request message and, in step 712, the meter 114 retrieves the requested meter data. In step 714, the meter 114 transmits the requested data, via the interface 112, to the processor 104 of the device 100. In step 716, the processor 104 receives the requested data. In step 718, the processor 104 buffers the requested data and, in step 718, adjusts the baud rate as necessary and forwards the requested data to the modem 108, which, in step 720, forwards the requested data, as outgoing data, via the communications network 118, to the remote control station 120. In step 722, the remote control station 120 receives the requested data and, in step 724, processes or stores the requested data in a suitable manner. It is understood that the request message may be a request for meter billing data, diagnostic data, or the like, or the message may instead comprise code for programming the meter 114.

The invention is operable through the two interfaces 112 and 122 to communicate with the meter 114 and modem 108 simultaneously. By way of example, while the modem 108 is interfaced to, and executing a communication session with, the meter 114, a different communication session may also be executed with the modem 108 via an RS-232 communication port interface.

The modem 108 may be configured via the RS-232 port 122. Accordingly, AT commands may be sent via the communication port 122 to the modem 108 while the device 100 is connected to the electric meter 114, i.e., without removing the device 100 from the meter 114. The communication port 122 also allows for other diagnostics to be performed, such as, by way of example, determining modem configuration and signal strength and quality.

The processor 104 may take a standard AT command annunciated from the meter 114 and change it from a telephony command to a TCP-IP connection. By way of example, the meter 114 may send an AT command ATDT2145551212, and the processor 104 may send a control signal back to the meter 114, and issue a TCP-IP call to a static IP address 12-123-123-12 that hosts the necessary software to receive the data call. It may be appreciated that this function allows the device attached to the modem to simulate a telephony circuit call without any special features or firmware update.

By the use of the present invention and method for facilitating wireless communication and acquisition of meter reading data from conventional solid state electric meters, as well as other types of meters, such as gas meters, water meters, automatic teller machines (ATM's), remote terminal units (RTU), end point devices, and the like.

It is understood that the present invention may take many forms and embodiments. Accordingly, several variations may be made in the foregoing without departing from the spirit or the scope of the invention. For example, the functionality, including buffering, embodied by the processor 104 may be incorporated into the modem 108.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A device for monitoring a meter, the device comprising:
an antenna adapted for receiving via a digital wireless cellular communications network incoming data from a remote control station, and for transmitting via a wireless cellular communications network outgoing data to said remote control station;
a cellular modem connected to said antenna for establishing a wireless telephony data connection;
a processor connected to said modem for receiving and processing incoming data, and for processing and communicating outgoing data to said modem for transmission via said antenna and said wireless cellular communications network to said remote control station;
a communication interface connected to said processor and connectable to said meter for communicating incoming data from said processor to said meter, and for communicating said outgoing data from said meter to said processor; and
a power supply connected for supplying power to said processor and said modem.

2. The device of claim 1, wherein said communication interface is a serial communication interface.

3. The device of claim 1, wherein said communication interface is operable utilizing a transitor-to-transitor logic (TTL) communication protocol.

4. The device of claim 1, wherein said communication interface is operable utilizing an RS-232 communication protocol.

5. The device of claim 1, wherein said communication interface further comprises an optical-isolation circuit effective for electrically isolating said device from the meter.

6. The device of claim 1, wherein said processor is operable for buffering data.

7. The device of claim 1, wherein said processor further comprises two or more communication ports and Universal Synchronous/Asynchronous Receiver/Transmitters (USARTs) operable for simultaneous communications with two or more components.

8. The device of claim 1, wherein said antenna is adapted for communicating at two or more frequencies.

9. The device of claim 1, wherein said antenna is configured for being mounted within said meter.

10. The device of claim 1, wherein said antenna is configured for being mounted externally of said meter.

11. The device of claim 1, wherein said modem is a circuit-switched modem.

12. The device of claim 1, wherein said device is configured for being mounted within said meter.

13. The device of claim 1, wherein said device is configured for being mounted externally of said meter.

14. The device of claim 1, wherein said power supply is adapted for receiving power externally from the power source supplying power to said meter.

15. The device of claim 1, wherein said power supply is an auto-ranging power supply.

16. The device of claim 1, wherein said power supply is an auto-ranging power supply adapted for receiving power having a voltage from about 80 volts AC RMS to about 520 volts AC RMS.

17. The device of claim 1, wherein said power supply comprises a battery.

18. The device of claim 1, wherein said modem is operable for receiving incoming data and transmitting outgoing data utilizing a protocol comprising one of IS-95A/B, Dynamic Host Configurable Protocol (DHCP), and a static Internet protocol (IP).

19. The device of claim 1, further comprising a serial communications port connected to said processor for facilitating diagnostics of said device, diagnostics of said meter, diagnostics of a remote terminal unit (RTU), programming of said meter, programming of said modem, programming of said processor, communications with other end point devices.

20. The device of claim 1, further comprising a TTL port connected to said processor for facilitating diagnostics and programming of said processor and said modem.

21. The device of claim 1, wherein said meter is at least one of an electric meter, a gas meter, a water meter, an automated teller machine (ATM), a remote terminal unit (RTU), and an endpoint device comprising at least one of a pump, an electric power regulator, capacitors, relays, an operational control reclosure (OCR), a device which may be monitored via a communications interface, a device requiring changes, and a device requiring a status update.

22. A method for monitoring a meter, comprising steps of:
receiving from a remote control station via a modem a message requesting meter data;
forwarding said message from said modem to said meter;
receiving said meter data from said meter; and
forwarding said meter data to said modem for communication to said remote control station.

23. The method of claim 22, wherein said step of receiving a message further comprises receiving said message via a wireless digital cellular communications network.

24. The method of claim 22, wherein said step of forwarding said message further comprises buffering said message and adjusting the baud rate of the transmission of said message from said modem to said meter.

25. The method of claim 22, wherein said step of forwarding said data to said modem further comprises buffering said data and adjusting the baud rate of the transmission of said message from said meter to said modem.

26. The method of claim 22, wherein said communication to said remote control station further comprises communication via a wireless digital cellular communications network to said remote control station.

27. The method of claim 22, wherein said steps of forwarding said message and receiving said meter data further comprise using a transistor-to-transistor logic (TTL) communication protocol.

28. The method of claim 22, further comprising the step of entering a wait state following of step of forwarding said message from said modem to said meter and until the step of receiving said meter data from said meter.

29. The method of claim 22, wherein at least a portion of the steps of receiving a message and forwarding said message are performed simultaneously.

30. The method of claim 22, wherein at least a portion of the steps of receiving said meter data and forwarding said meter data are performed simultaneously.
